(19) United States
(12) Patent Application Publication
(10) Pub. No.: US 2011/0060860 A1
(43) Pub. Date: Mar. 10, 2011

(54) BACKPLANE NETWORK DISTRIBUTION

(76) Inventor: Mats Rimborg, Göteborg (SE)

(21) Appl. No.: 12/991,562

(22) PCT Filed: May 7, 2008
(86) PCT No.: PCT/SE08/00310

§ 371 Date: Nov. 8, 2010

(51) Int. Cl. G06F 13/00

(52) U.S. Cl. 710/317

(57) ABSTRACT

A backplane arrangement 200; 500 and method for distributing network connections in said backplane arrangement 200; 500 comprising a number of board positions Ac-Fc; Gc-Kc each arranged to operatively receive a board Ab-Fb; Gb-Kb, and a backplane-network arrangement 250, 300; 550, 600, 600′ arranged to operatively make a plurality of network connections a-n; a-g available at a first board position Ac; Gc. The backplane arrangement 200; 500 is characterized in f/?af a first allocation arrangement Aen1-Aen14; Gen8-Gen14 is arranged to operatively allocate a set of the available network connections a-n; a-g to be used by a board Ab received in the first board position Ac; Gc; and a first bypass arrangement Ap; Aps; Aps'; Gp is arranged to operatively bypass a set of the available network connections b-n; b-g unallocated at the first board position Ac; Gc to a second subsequent board position Bc; Hc via the backplane-network arrangement 250; 550.

### BACKGROUND OF THE INVENTION

1. Technical Field

Recent backplane standards, e.g. the Advanced Telecom Computing Architecture (ATCA), generally use network technologies such as e.g. Ethernet, PCI Express or RapidIO etc. for the communication between circuit boards arranged in slots provided by a backplane in a magazine, e.g. a rack or similar.

As is well known, the ATCA mentioned above is a large specification effort from the PCI Industrial Computer Manufacturers Group (PICMG), with more than 100 companies participating. The ATCA effort is also known as AdvancedTCA™ and the official specification designation is PICMG 3.x. The ATCA is targeted to requirements for the next generation of “carrier grade” communications equipment. The series of specifications incorporate the latest trends in high speed interconnecting technologies, next generation processors and improved Reliability, Availability and Serviceability (RAS). Various ATCA-based backplane systems have also been discussed in the patent literature, see e.g. patent application US 2007/0104091 (Lee et al.) published in May 10, 2007.

It is also well known that a backplane can be implemented by using various network technologies (e.g. such as the Ethernet mentioned above) in connection with different topologies, such as e.g. ring (see FIG. 1a), a mesh (see FIG. 1b), a fully connected mesh (see FIG. 1c), a star (see FIG. 1d), a line (see FIG. 1e), a tree (see FIG. 10 or bus (see FIG. 1g) etc., or even in connection with a combination of one or more of these exemplifying topologies or similar.

Existing backplane implementations provide a fixed number of network connections to each board connector or similar in the backplane, e.g. a fixed number of Ethernet connections or similar. Hence, a circuit board or similar inserted in a specific connector in the backplane will always have access to a fixed number of network connections for communicating with other network units, i.e. primary with other circuit boards or similar inserted in other connectors of the backplane. However, in general all circuit boards in a magazine do not have the same bandwidth need for their backplane network connection. Hence, a circuit board may need a number of network connections that is a higher or lower than the fixed number of connections that is available in a certain board connector.

In view of the above, it would be advantageous if the network connections provided by the backplane could be used in a more flexible manner, so that different boards could allocate a different number of network connections, independent of the board connector or similar in which the boards are positioned in the magazine.

### SUMMARY OF THE INVENTION

According to the invention the network connections provided by a backplane will be used in a more flexible manner whereby different boards can allocate a different number of network connections, independent of the board connector or similar in which the boards are positioned in the magazine.

This has been accomplished by using a network switch arrangement to make a number of network connections available in the backplane at a first slot position. The board at that location allocates as many of the available connections as it needs—0, 1, 2, or even more depending on the bandwidth required by the board in question and depending on the number of available connections—and feeds the rest of the available connections through to the next slot. The second board at the next slot also allocates the number of connections it needs and feeds the rest through to the next slot, and so on. Any unused positions in a slot may e.g. have a simple plug arrangement attached, to let all available connections pass through to the next position.

In particular, this has been accomplished by a first aspect of the invention directed to a backplane arrangement comprising a number of board positions each arranged to operatively receive a board, and a backplane-network arrangement arranged to operatively make a plurality of network connections available at a first board position, wherein: a first allocation arrangement is arranged to operatively allocate a set of the available network connections to be used by a board received in the first board position, and a first bypass arrangement is arranged to operatively bypass a set of the available network connections unallocated at the first board position to a second subsequent board position via the backplane-network arrangement.

Here, it should be emphasised that the first board position may be any board position that precedes a second subsequent board position in the backplane.

A second embodiment of the invention includes the features of the first aspect and wherein, said backplane-network arrangement is arranged to operatively make said plurality of network connections available at a second board position, and wherein a second allocation arrangement is arranged to operatively allocate a redundant set of the network connections unallocated at the first board position to be used by a board received in the second board position.

A third embodiment of the invention includes the features of the first embodiment and wherein a second bypass arrangement is arranged to operatively bypass a set of the available network connections unallocated at the second board position to the first board position via the backplane-network arrangement, and wherein a third allocation arrangement is arranged to operatively allocate a redundant set of the network connections unallocated at the second board position to be used by a board received in the first board position.

A fourth embodiment of the invention includes the features of the first, second or third embodiment and wherein each bypass arrangement is arranged to bypass the unallocated network connections from network entry points to predetermined network exit points starting and proceeding in a pattern from the same network exit point in each board position.

Here it should be emphasised that the network connections not allocated in a first board position will always be available for further use in a second board position at known and predetermined positions in the first board position. Particularly, at said same network exit point in every board first position but possibly also at other network exit points that are distributed in the first board connector according to a known pattern, e.g. consecutively from said same network exit point in each first board connector.

A fifth embodiment of the invention includes the features of the first, second, third or fourth embodiment and wherein the first bypass arrangement is arranged to operatively bypass the network connections unallocated at the first board position from network entry points at the first board position to corresponding network exit points at the first board position, displaced by the number of network connections unallocated at the first board position.

A sixth embodiment of the invention includes the features of the second embodiment and wherein the second bypass arrangement is arranged to operatively bypass the network connections unallocated at the second board position from network entry points at the second board position to corresponding network exit points at the second board position, displaced by the number of network connections unallocated at the second position.

A seventh embodiment of the invention includes the features of the first or the second embodiment and wherein at least one of said first or second bypass arrangement is a network switching arrangement that is arranged to operatively in a first switching position bypass the unallocated network connections from network entry points at said board position to corresponding network exit points at said board position, displaced by the number of network connections unallocated at said board position, and in a second switching position bypass the unallocated network connections from network entry points at said board position to corresponding network exit points at said board position without any displacement.

An eighth embodiment of the invention includes the features of the first or second embodiment and wherein at least one of said first or second bypass arrangement is a network switching arrangement that is arranged to operatively bypass the unallocated network connections from their network entry points respectively at said board position to any network exit point at said board position, so as to provide a point-to-point connection between each of said network entry points and a network exit point.

A ninth embodiment of the invention includes the features of the first, second, third, fourth, fifth, sixth, seventh or eighth embodiment and wherein at least one of said bypass arrangements is a part of the board inserted at the board position in question.

A tenth embodiment of the invention is directed to a board magazine comprising a backplane according to the first, second, third, fourth, fifth, sixth, seventh, eighth or ninth embodiment.

The problems and advantages indicated above have also been met by a second aspect of the invention directed to a method for distributing network connections in a backplane arrangement comprising a number of board positions each arranged to operatively receive a board, and a backplane-network arrangement arranged to operatively make a plurality of network connections available at a first board position. The method comprises the steps of: at a first allocation arrangement, allocating a set of the available network connections to be used by a board received in the first board position; and at a first bypass arrangement, bypassing a set of the available network connections unallocated at the first board position to a second subsequent board position via the backplane-network arrangement.

A twelfth embodiment of the invention includes the features of the second aspect and comprises the steps of: by said backplane-network arrangement, making said plurality of network connections available at a second board position; and at a second allocation arrangement, allocating a redundant set of the network connections unallocated at the first board position to be used by a board received in the second board position.

A thirteenth embodiment of the invention includes the features of the twelfth embodiment and comprises the steps of: at a second bypass arrangement, bypassing a set of the available network connections unallocated at the second board position to the first board position via the backplane-network arrangement; at a third allocation arrangement, allocating a redundant set of the network connections unallocated at the second board position to be used by a board received in the first board position.

A fourteenth embodiment of the invention includes the features of the eleventh, twelfth or thirteenth embodiment and comprises the steps of: at each bypass arrangement, bypassing the unallocated network connections from network entry points to predetermined network exit points starting and proceeding in a pattern from the same network exit point in each board position.

A fifteenth embodiment of the invention includes the features of the eleventh, twelfth, thirteenth or fourteenth embodiment and comprises the steps of: at the first bypass arrangement, bypassing the network connections unallocated at the first board position from network entry points at the first board position to corresponding network exit points at the first board position, displaced by the number of network connections unallocated at the first board position.

A sixteenth embodiment of the invention includes the features of the twelfth embodiment and comprises the steps of: at the second bypass arrangement, bypassing the network connections unallocated at the second board position from network entry points at the second board position to corresponding network exit points at the second board position, displaced by the number of network connections unallocated at the second position.

A seventeenth embodiment of the invention includes the features of the eleventh or thirteenth embodiment and comprises the steps of: in at least one of said first or second bypass arrangement being a network switching arrangement, bypassing in a first switching position the unallocated network connections from network entry points at said board position to corresponding network exit points at said board position, displaced by the number of network connections unallocated at said board position, and in a second switching position bypassing the unallocated network connections from network entry points at said board position to corresponding network exit points at said board position without any displacement.

An eighteenth embodiment of the invention includes the features of the eleventh or thirteenth embodiment and comprises the steps of: in at least one of said first or second bypass arrangement being a network switching arrangement, bypassing the unallocated network connections from their network entry points respectively at said board position to any network exit point at said board position, so as to provide a point-to-point connection between each of said network entry points and a network exit point.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that the steps in any methods defined by the appended claims may, without departing from the present invention, be performed in another order than the order in which they may appear in the claims.

### BRIEF DESCRIPTION OF THE DRAWINGS

FIG. 1a-1g are schematic illustrations of examples of various network topologies which can be utilized in connection with the invention,

FIG. 2a is a schematic illustration of an exemplifying magazine 100,

FIG. 2b is a schematic side view of the magazine 100 in FIG. 2a,

FIG. 3 is a schematic front view of a first exemplifying backplane 200 adapted to be fitted into the magazine 100,

FIG. 4a is a schematic illustration of board position Ac provided with bypass arrangements Aps implemented by means of a switching arrangement according to a first embodiment,

FIG. 4b is a schematic illustration of board position Ac provided with bypass arrangements Aps′ implemented by means of a switching arrangement according to a second embodiment,

FIG. 5 is a schematic front view of another exemplifying backplane 500 adapted to be fitted into the magazine 100,

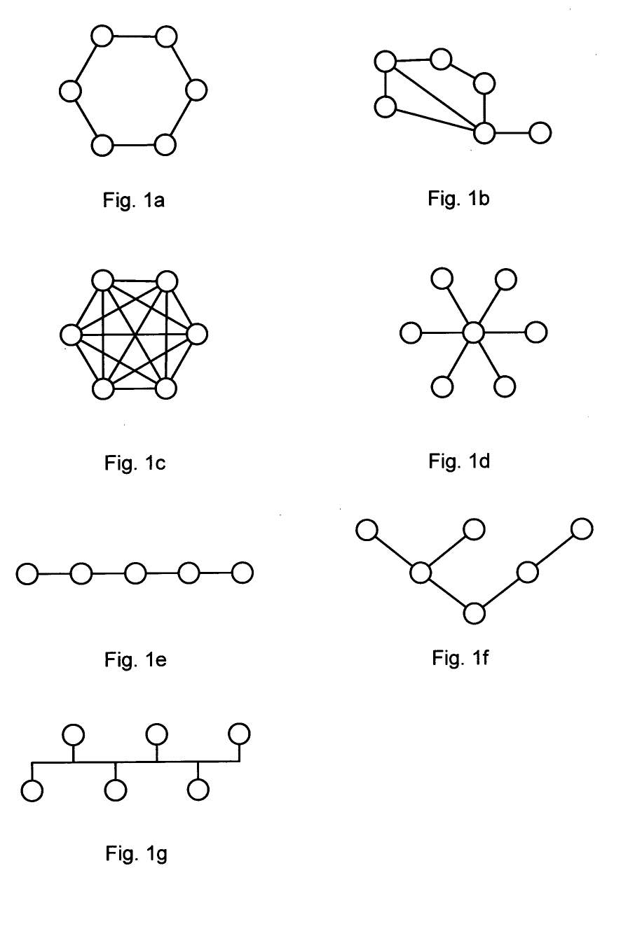

### DETAILED DESCRIPTION OF PREFERRED EMBODIMENTS

The exemplifying embodiments described below are based on a board magazine comprising a backplane with a number of board positions, and a backplane-network arrangement arranged to operatively distribute a number of network connections to the board positions and to boards inserted therein.

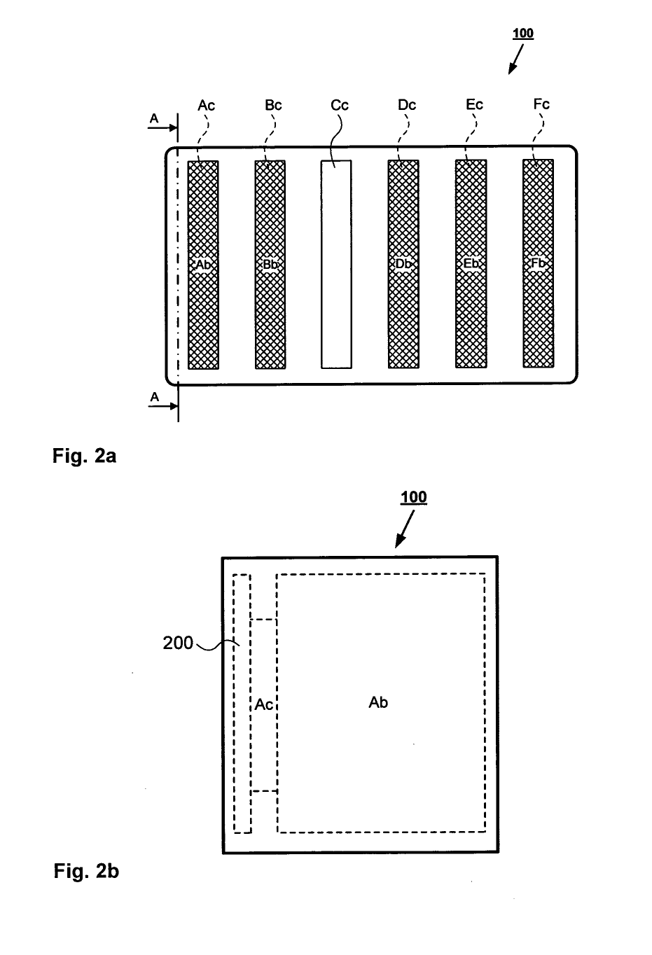

FIG. 2a is a schematic illustration of an exemplifying board magazine 100. FIG. 2b is a schematic side-view of the magazine 100 in FIG. 2a, seen in the direction indicated by the arrows A-A in FIG. 2a. As can be seen in FIG. 2a-2b the magazine 100 comprises a first exemplifying backplane 200, and at least a first board position Ac in which a first board Ab is inserted. The backplane 200, the board position Ac and the board Ab have been indicated by dashed lines in FIG. 2b since they are arranged inside the magazine 100.

The board or boards now discussed are typically circuit boards provided with various electric circuits or similar, and the board connectors now discussed are typically provided with various connection pins or similar adapted to connect a board and the electric circuits of the board to a backplane-network (not shown in FIG. 2a-2b) comprised by the backplane. Amongst other things the backplane-network enables communication between boards in the backplane and other equipment connected to the backplane of the magazine.

Backplanes with board connectors connected to various backplane-networks of the backplane, and boards adapted to be inserted in such connectors are well known per se to those skilled in the art. Hence, there is no need for a detailed description of the general structure and function of these features as such. However, specific details will be discussed below with reference to embodiments of the present invention.

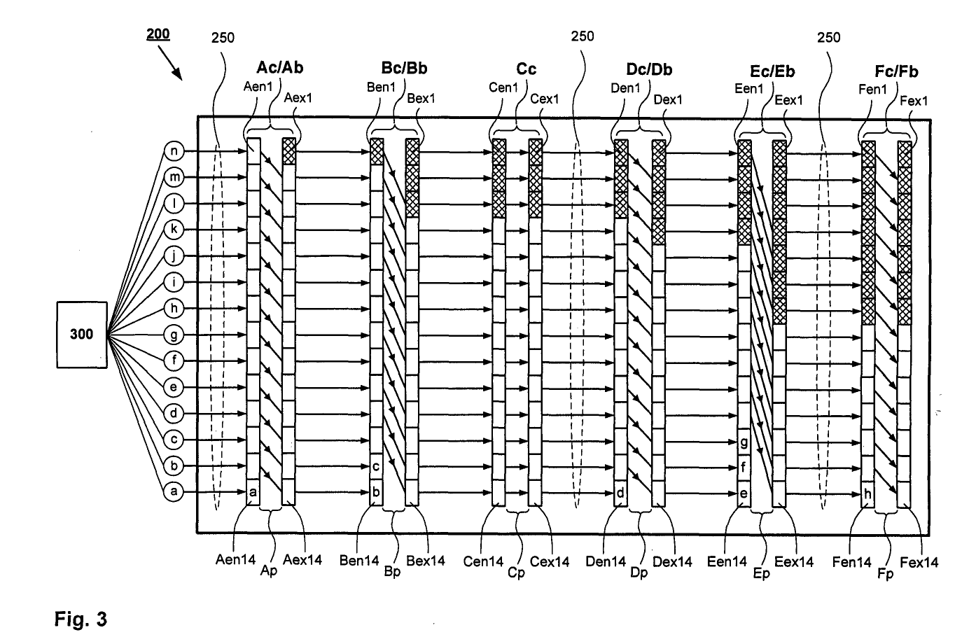

The attention is now directed to FIG. 3, which shows a schematic front view of the first exemplifying backplane 200, adapted to be arranged in the board magazine 100 shown in FIG. 2a-2b. As can be seen in FIG. 3 the backplane 200 comprises six (6) board positions, preferably implemented as circuit board connectors Ac-Fc or similar. FIGS. 3 and 2a illustrate that only the board connectors Ac, Bc, Dc, Ec, Fc in the exemplifying backplane 200 of the magazine 100 are provided with a circuit board Ab, Bb, Db, Eb, Fb respectively that requires one or more network connections. In other words, there is no board inserted in the board position Cc of the exemplifying backplane 200, alternatively the board inserted in board position Cc requires no network connection. Since the board connectors Ac, Bc, Dc, Ec, Fc in FIG. 2a are hidden by boards Ab, Bb, Db, Eb, Fb inserted therein, the board connectors Ac, Bc, Dc, Ec, Fc have been indicated by reference markings with dashed lines.

In addition, an exemplifying backplane-network 250 of the backplane 200 has been schematically illustrated in FIG. 3. It is preferred that the backplane-network 250 is a part of the backplane 200. The backplane-network 250 may e.g. be implemented by means of circuit paths in a substrate of the backplane 200, or by means of wires or similar that are attached by soldering or wire wrapping to pins or similar of the board connectors Ac-Fc.

The backplane-network 250 is illustrated by horizontal arrows each representing one or several connection lines (e.g. circuit paths or wires or similar) that connects one or several connection pins or similar of a first board connector Ac-Fc to the connection pin(s) or similar of a second board connector Ac-Fc.

In FIG. 3 the connection pins or similar of each exemplifying board connector Ac-Fc defines fourteen (14) network entry points and fourteen (14) network exit points.

Thus, at least parts of the backplane-network 250 are illustrated by:
arrows connecting network exit points Aex1-Aex14 in board connector Ac with corresponding network entry points Ben1-Ben14 in board connector Bc, and
arrows connecting the network exit points Bex1-Bex14 in board connector Bc with corresponding network entry points Cen1-Cen14 in board connector Cc, and
arrows connecting the network exit points Cex1-Cex14 in board connector Cc with corresponding network entry points Den1-Den14 in board connector Dc, and
arrows connecting the network exit points Dex1-Dex14 in board connector Dc with corresponding network entry points Een1-Een14 in board connector Ec, and
arrows connecting network exit points Eex1-Eex14 in board connector Ec with corresponding network entry points Fen1-Fen14 in board connector Fc.

It is preferred that the connection pins or similar of each board connector Ac-Fc is arranged to operatively connect the backplane-network 250 to the electric circuits of a board inserted in the board connector in question. Once a board is inserted in a board connector and thus connected to the backplane-network 250 it will be able to communicate with other boards in the backplane 200, and with other equipment connected to the backplane-network 250 of the backplane 200. There are a wide variety of known board connectors provided with various pin arrangements or similar that can be utilized for connecting the electric circuits or similar of a circuit board or similar to a backplane-network. Hence, the general features and function of a board connector and its pin arrangement or similar need no further description.

In FIG. 3 the network entry points for each exemplifying board connector Ac-Fc have been schematically illustrated by a left column of 14 rectangles, whereas the network exit points have been schematically illustrated by a right column of 14 rectangles arranged adjacent to the right column. Each rectangle symbolizes the number of connection pins or similar which the network technology in question (e.g. Ethernet or similar as discussed above) needs to use for the network entry and exit points within each board connector Ac-Fc.

In the first board connector Ac the first network entry point has been labelled Aen1 and the last network entry point has been labelled Aen14. Similarly, the first network exit point has been labelled Aex1 and the last network exit point has been labelled Aex14. This applies mutatis mutandis to the other board connectors Bc-Fc. As will be described in more detail later, the network entry points of the board connectors Ac-Fc are used to allocate network connections a-n at the board connector Ac-Fc in question.

The teaching from FIG. 3 can be generalized such that the first network entry point of an arbitrary board connector Yc is labelled Yen_{—}1 and the last network entry point is labelled Yen_n, whereas the first network exit point is labelled Yex_{—}1 and the last network exit point is labelled Yex_n. The last n of the labels Yen_n and Yex_n illustrates that there may be an arbitrary number of n network entry and exit points, which indicates that the number of entry and exit points of a board connector Yc may be equal in some embodiments. However, the number of network entry and exit points may be different for some or all board connectors in a set of board connectors in a backplane. This may be illustrated in that an arbitrary board connector Yc may have a first number of n1 entry and exit points, whereas another board connector Yc′ may have a second number of n2 entry and exit points. Furthermore, the number of network entry and exit points may be different for a single board connector Yc, which may have a number of n1 network entry point and a number of n1′ network exit points. Here, it may be preferred that n1 is larger than n1′.

It is also schematically illustrated in FIG. 3 that a network switch arrangement 300 can be used to make a number of network connections available to the backplane-network 250, e.g. Ethernet connections or similar as discussed above. Such network switches are well known per se to those skilled in the art and they need no further description. In FIG. 3 it is preferred that fourteen (14) network connections labelled a-n are made available by the switch arrangement 300 at a first board position Ac, e.g. made available at the network entry points Aen1-Aen14 of the first board connector Ac. The fourteenth network connection has been labelled n as a matter of convenience only and it has noting to do with the fact that n is the fourteenth letter in the alphabet. The exemplifying backplane-network 250, the board connectors Ac-Fc and a number of bypass arrangements Ap-Fp will then distribute the network connections a-n to the other board positions Bc-Fc as will be further described below.

Before we proceed, it should be emphasised that alternatives to the network switch 300 can be used to make the network connections a-n available to the backplane-network 250 at a certain board position Ac-Fc, e.g. at the first board position Ac as indicated above. Alternatives may e.g. be a wire arrangement or a cable arrangement or similar.

As can be seen in FIG. 3 the first network connection a) of the available network connections a-n is allocated by the network entry point Aen14 in the first board position Ac. Hence, the network entry point Aen14 is used as a network connection allocation arrangement for a first circuit board Ab. The remaining network connections b-n are bypassed from the network entry points by a bypass arrangement Ap to the corresponding network exit points in the board position Ac, displaced by the number of allocated network connections, i.e. displaced by one step in this case.

In other words, Aen1 is bypassed to Aex2, Aen2 is bypassed to Aex3, Aen3 is bypassed to Aex4, Aen4 is bypassed to Aex5, Aen5 is bypassed to Aex6, Aen6 is bypassed to Aex7, Aen7 is bypassed to Aex8, Aen8 is bypassed to Aex9, Aen9 is bypassed to Aex10, Aen10 is bypassed to Aex11, Aen11 is bypassed to Aex12, Aen12 is bypassed to Aex13 and Aen13 is bypassed to Aex14. In turn, the network exit points Aex1-Aex14 are connected by the backplane-network 250 to the corresponding network entry points Ben1-Ben14 of the second board connector Bc.

The second and third network connections b-c are allocated by the network entry points Ben13-Ben14 respectively in the second board position Bc. Hence, the network entry points Ben13-Ben14 are used as a network connection allocation arrangement for a second circuit board Bb. The remaining network connections d-n are bypassed from the network entry points by a bypass arrangement Bp to the corresponding network exit points in the board position Bc, displaced by the number of allocated network connections, i.e. displaced by two steps in this case.

In other words, Ben1 is bypassed to Bex3, Ben2 is bypassed to Bex4, Ben3 is bypassed to Bex5, Ben4 is bypassed to Bex6, Ben5 is bypassed to Bex7, Ben6 is bypassed to Bex8, Ben7 is bypassed to Bex9, Ben8 is bypassed to Bex10, Ben9 is bypassed to Bex11, Ben10 is bypassed to Bex12, Ben11 is bypassed to Bex13 and Ben12 is bypassed to Bex14. In turn, the network exit points Bex1-Bex14 are connected by the backplane-network 250 to the corresponding network entry points Cen1-Cen14 of the third board connector Cc.

In the third board connector Cc there is no board inserted, alternatively the board inserted in connector Cc requires no network connection. Hence, no network connection is allocated in the board position Cc. The unallocated network connections d-n remaining from the allocation in the second board connector Bc are bypassed from the network entry points Cen1-Cen14 by a bypass arrangement Cp to the corresponding network exit points Cex1-Cex14 in the board position Cc. In turn, the network exit points Cex1-Cex14 are connected by the backplane-network 250 to the corresponding network entry points Den1-DCen14 of the fourth board connector Dc.

The fourth network connection d) is allocated by the network entry point Den14 in the fourth board position Dc. Hence, the network entry point Den14 is used as a network connection allocation arrangement for a third circuit board Db. The remaining network connections e-n are bypassed from the network entry points by a bypass arrangement Dp to the corresponding network exit points in the board position Dc, displaced by the number of allocated network connections, i.e. displaced by one step in this case.

In other words, Den1 is bypassed to Dex2, Den2 is bypassed to Dex3, Den3 is bypassed to Dex4, Den4 is bypassed to Dex5, Den5 is bypassed to Dex6, Den6 is bypassed to Dex7, Den7 is bypassed to Dex8, Den8 is bypassed to Dex9, Den9 is bypassed to Dex10, Den10 is bypassed to Dex11, Den11 is bypassed to Dex12, Den12 is bypassed to Dex13 and Den13 is bypassed to Dex14. In turn, the network exit points Dex1-Dex14 are connected by the backplane-network 250 to the corresponding network entry points Een1-Een14 of the fifth board connector Ec.

The fifth, sixth and seventh network connections e-g are allocated by the network entry points Een12-Een14 respectively in the fifth board position Ec. Hence, the network entry points Een12-Een14 are used as a network connection allocation arrangement for a fourth circuit board Eb. The remaining network connections h-n are bypassed from the network entry points by a bypass arrangement Ep to the corresponding network exit points in the board position Ec, displaced by the number of allocated network connections, i.e. displaced by three steps in this case.

In other words, Een1 is bypassed to Eex4, Een2 is bypassed to Eex5, Een3 is bypassed to Eex6, Een4 is bypassed to Eex7, Een5 is bypassed to Eex8, Een6 is bypassed to Eex9, Een7 is bypassed to Eex10, Een8 is bypassed to Eex11, Een9 is bypassed to Eex12, Een10 is bypassed to Eex13 and Een11 is bypassed to Eex14. In turn, the network exit points Eex1-Eex14 are connected by the backplane-network 250 to the corresponding network entry points Fen1-Fen14 of the sixth board connector Fc.

The eighth network connection h) is allocated by the network entry point Fen14 in the fifth board position Fc. Hence, the network entry point Fen14 is used as a network connection allocation arrangement for a fifth circuit board Fb. The remaining network connections i-n are bypassed from the network entry points by a bypass arrangement Fp to the corresponding network exit points in the board position Fc, displaced by the number of allocated network connections, i.e. displaced by one step in this case. This corresponds mutatis mutandis to the displacement made by the bypass arrangement Dp previously described in connection with the fourth board position Db.

The allocation of network connections described above can be summarized in that a first number of the available network connections are allocated at a preceding first board position for a first circuit board—e.g. a number of 0, 1, 2 or 3 connections or even more depending on the bandwidth required by the first board and depending on the number of network connections available in the first board position. The rest of the available connections are fed through to a subsequent second board position. In the second board position a second number of the available network connections (i.e. the unallocated connections fed through from the first board position) is allocated for a second board—e.g. a number of 0, 1, 2 or 3 connections or even more depending on the bandwidth required by the second board and depending on the number of network connections available in the second board position. The rest of the available connections are fed through to a third board position, where a number of network connections needed for a third board are allocated, and so on through all the board connections in the backplane that are to be populated by boards.

In the example discussed above, between 0 and 3 network connections are allocated at each board position Ac-Fc in FIG. 3. This has been illustrated by the letters a-h inserted in the appropriate rectangles in FIG. 3. In addition, rectangles marked with a mesh pattern symbolize entry and/or exit points where there are no network connections available. In FIG. 3 seven (7) unused (white) network connections remain in the last board position Fc.

One or more of the bypass arrangements Ap-Fp mentioned above may e.g. be implemented by means of conducting paths or wires or similar that connects the entry points to the exit points of the board connector Ac-Fc in question. Conductive paths or similar may e.g. be embedded in a substrate of the backplane 200. Wires or similar may e.g. be soldered or wire wrapped to the pins or similar of the network entry and exit points. Alternatively, one or more of the bypass arrangements Ap-Fp may be implemented by wires or conductors or similar that are embedded in a separate plug arrangement or similar being applied (possibly detachable) to the board connector Ac-Fc in question. Such plugs may e.g. be applied on the connection pins or similar of a board connector. However, this may require that the pins or similar—in addition to protruding at the board side of the connector so as to be available for an inserted board—also protrudes at the opposite side of the board connector so as to be available for the plugs now discussed. In addition, one or more of the bypass arrangements Ap-Fp may be a part of the board connector Ac-Fc.

In a more preferred embodiment the bypass arrangements Ap-Fp are a part of the boards Ab-Fb respectively intended to be inserted in a board connector Ac-Fb. In this manner the number of network connections allocated at a certain board position Ac-Fc will be determined by the configuration of the specific board Ab-Fb inserted therein. Hence, the same or substantially the same backplane 200 can be used for different configurations of boards Ab-Fb. For example, the backplane will be insensitive or at least less sensitive to the actual position (Ac-Fc) of the board (Ab-Fb), i.e. a board (Ab-Fb) may be inserted in any connector (Ac-Fc).

Before we proceed it should also be emphasised that the bypass arrangements mentioned herein are considered to be a part of the backplane-network 250 and its function, even if the bypass arrangements is e.g. partly or fully arranged in a board connector and/or on a circuit board to be inserted in a board connector. A greater flexibility may be obtained by providing a dynamic allocation of the distributed network connections a-n being available for the individual board connectors Ac-Fc. This can e.g. be achieved by implementing one or more of the bypass arrangements Ap-Fp by means of switches or similar, e.g. semiconductor switches or similar. It is preferred that switches or similar are arranged to operatively switch the network connections available to a board connector Ac-Fc so as to let the network connections either be allocated by a network entry point or bypassed to a network exit point of the board connector Ac-Fc in question.

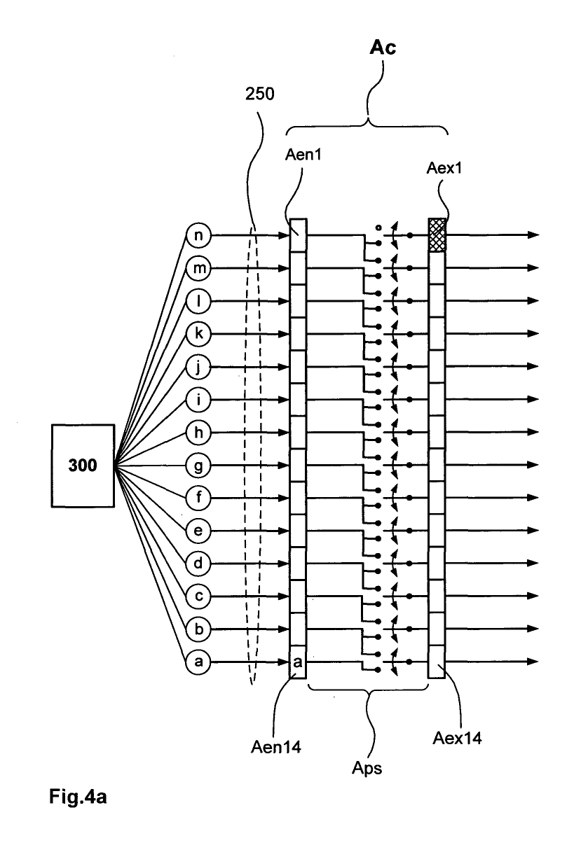

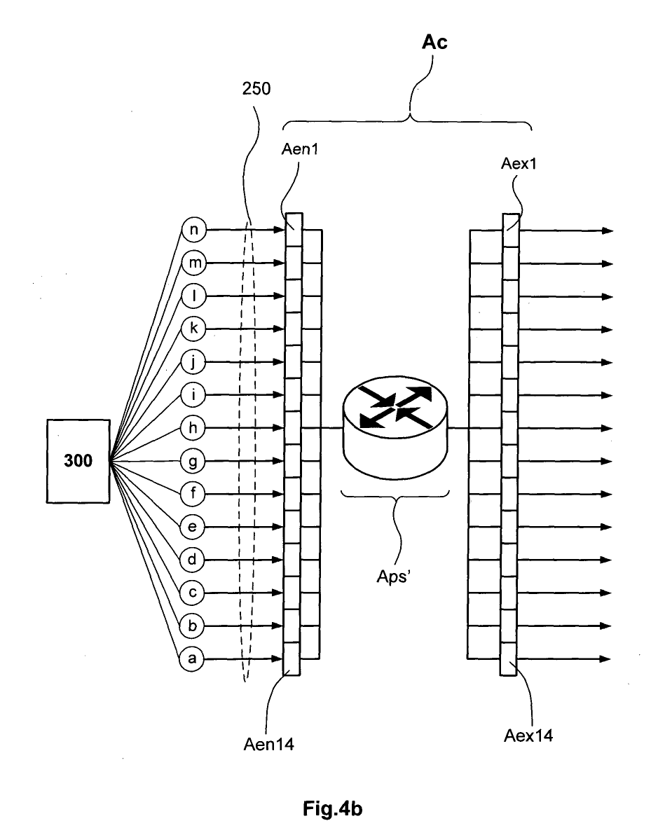

In FIG. 4a, fourteen (14) switches, e.g. semiconductor switches or similar, have been implemented in a first exemplifying switching bypass arrangement Aps at the first board connector Ac. Each switch in the exemplifying bypass arrangement Aps has been illustrated by a schematic single pole changeover switch. The schematic single pole switch represents the number and design etc. of the switches required for switching a network connection, which e.g. may depend on the number of connection pins or similar needed for the network technology in question (e.g. Ethernet or similar as discussed above). For example, a Gigabit Ethernet network connection may need eight (8) poles, corresponding to eight (8) connection pins.

In FIG. 4a, the switches in the bypass arrangement Aps are arranged to operatively bypass the network connections b-n (being unallocated at the connector Ac as previously described) from network entry points Aen1-Aen13 to the corresponding network exit points displaced by the number of network connections allocated at the first board position, i.e. displaced by one (1) since only one network connection is allocated at the connector Ac. In other words, the network connections provided to the network entry points Aen1-Aen13 are bypassed to the network exit points Aex2-Aex14 respectively as previously described. In addition, the switches in the bypass arrangement Aps are arranged to operatively and alternatively bypass all the network connections a-n from the network entry points Aen1-Aen14 to the corresponding network exit points Aex1-Aex14 respectively in case the operation of the board Ab inserted in connector Ac requires no network connection. This toggling function of the switches has been indicated by a double arrowed arc in each switch of the bypass arrangement Aps. It should be understood that the above applies mutatis mutandis for switching bypass arrangements arranged in any of the other connectors Bc-Fc.

When the bypass arrangement of a board connector is implemented as a switch arrangement, e.g. such as the switches in the exemplifying bypass arrangements Aps described above, it is possible to bypass and transfer a variable number of network connections in a board connector. The number of bypassed and transferred network connections depend on the number of network connections available at the board connector in question and the number of these connections that are allocated at the board connection in question. In other words, the number of bypassed and transferred network connections should preferably not exceed the number of available network connections that are left unallocated by the board connector in question.

In FIG. 4b, a second exemplifying switching bypass arrangement Aps′ has been implemented in the first board connector Ac. The bypass arrangement Aps′ is arranged so as to connect one or several or even all network connections a-n from any network entry point Aen-Aen14 to any network exit point Aex1-Aex14, preferably under the limitation that a point-to-point connection is established between a certain network entry point and a certain network exit point. In other words, one network entry point is preferably connected to only one network exit point. The bypass arrangement Aps′ has a router like function that is preferably implemented by means of switches, e.g. semiconductor switches or similar. Naturally, the actual dynamic allocation of the network connections a-n at each board connector Ac-Fc has to be carefully monitored, e.g. so that the number of allocated network connections does not exceed the number of available network connections etc. The connection by the switching arrangements may e.g. be performed and monitored by the network switch arrangement 300 or similar being provided with the appropriate software and hardware. It should be understood that the above applies mutatis mutandis for a switching bypass arrangement arranged in any of the other connectors Bc-Fc.

It should be emphasised that some board connectors may have a bypass arrangement that is partly implemented by means of a switching arrangement as described above and partly by conductor lines or wire arrangements or similar as previously described. Preferably it is ensured that the total number of available network connections in the backplane 200 does not get exceeded.

Moreover, it should be clear that a part of a board connector may be implemented by means of conductor lines or wire arrangements or similar as described above, whereas another part of the board connector is implemented by means of switch arrangements or similar as described above.

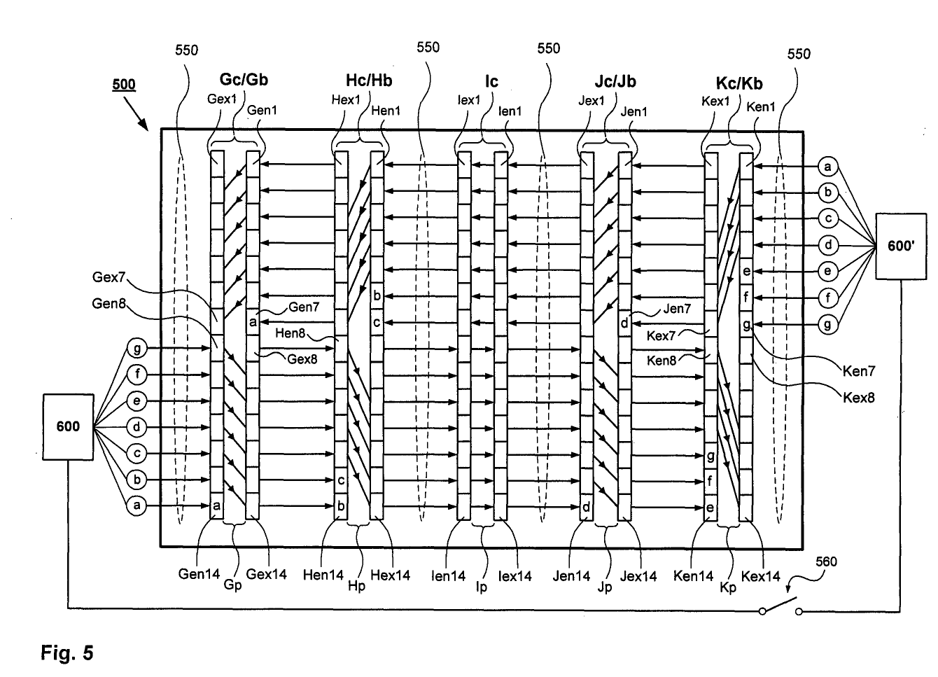

The attention is now directed to FIG. 5, which shows a schematic front view of a second exemplifying backplane 500, adapted to be arranged in the board magazine 100. As can be seen in FIG. 5, the backplane 500 comprises five (5) board positions preferably implemented by circuit board connectors Gc-Kc, and an exemplifying backplane-network 550. The backplane 500, the connectors Gc-Kc and the backplane-network 550 are all substantially similar or identical to the backplane 200, the connectors Ac-Fc and the backplane-network 250 that were described above.

As will described in more detail later, the connection pins or similar of each exemplifying board connector Gc-Kc in FIG. 5 define fourteen (14) network entry points and fourteen (14) network exit points.

Thus, in a first direction at least parts of the backplane-network 550 are illustrated by:
arrows connecting network exit points Gex8-Gex14 in board connector Gc with corresponding network entry points Hen8-Hen14 in board connector Hc, and
arrows connecting the network exit points Hex8-Bex14 in board connector Hc with corresponding network entry points Ien8-Ien14 in board connector Ic, and
arrows connecting the network exit points Iex8-Iex14 in board connector Ic with corresponding network entry points Jen8-Jen14 in board connector Jc, and
arrows connecting the network exit points Jex8-Jex14 in board connector Jc with corresponding network entry points Ken8-Ken14 in board connector Kc.

In a second direction at least parts of the backplane-network 550 are illustrated by:
arrows connecting network exit points Kex1-Kex7 in board connector Kc with corresponding network entry points Jen1-Jen7 in board connector Jc, and
arrows connecting network exit points Jex1-Jex7 in board connector Jc with corresponding network entry points Ien1-Ien7 in board connector Ic, and
arrows connecting network exit points Iex1-Iex7 in board connector Ic with corresponding network entry points Hen1-Hen7 in board connector Hc, and
arrows connecting network exit points Hex1-Hex7 in board connector Hc with corresponding network entry points Gen1-Gen7 in board connector Gc.

The connection pins or similar of each board connector Gc-Kc have the same function as the connection pins or similar of the connectors Ac-Fc previously described.

In FIG. 5 the network entry points and exit points for each exemplifying board connector Gc-Kc are schematically illustrated by rectangles.

In the first board connector Gc the first network entry point has been labelled Gen1 and the last network entry point has been labelled Gen14. Similarly, the first network exit point has been labelled Gex1 and the last network exit point has been labelled Gex14. As can be seen in FIG. 5 this applies mutatis mutandis to the other board connectors Hc-Kc.

The teaching from FIG. 5 can be generalized mutatis mutandis

to an arbitrary connector Yc amongst a set of connectors Yl-Yn as previously described with reference to FIG. 3.

In addition, a network switch arrangement 600, 600′ is schematically illustrated in FIG. 5. The network switch arrangement 600, 600′ is arranged to make a number of network connections available to the backplane-network 550, e.g. Ethernet connections or similar as discussed above. In this respect the network switch arrangement 600, 600′ respectively is the same as the network switch arrangement 300 shown in FIG. 3.

However, in FIG. 5 it is preferred that seven (7) network connections a-g are made available by a first network switch arrangement 600 at a first board position Gc, i.e. the network connections a-g are made available at the network entry points Gen8-Gen14 of the first board connector Gc. It is also preferred that the same seven (7) network connections a-g are made available by a second network switch arrangement 600′ at a second board position Kc, i.e. the network connections a-g are made available at the network entry points Ken1-Ken7 of the second board connector Kc. The backplane-network 550, the board connectors Gc-Kc and a number of bypass arrangements Gp-Kp are then arranged so as to distribute the network connections a-g to the other board positions Hc-Kc in a redundant manner as will be further described below.

Before we proceed it should be emphasised that alternatives to the network switch arrangement 600, 600′ may be used to make the network connections a-n available to the backplane-network 550 at certain board positions Gc-Kc. Alternatives may e.g. be a wire or cable arrangement or similar.

As can be seen in FIG. 5 the first network connection a) of the available network connections a-g is allocated by the pair of network entry points Gen7 and Gen14 at the first board position Gc. Hence, the network entry points Gen7, Gen14 are used as network connection allocation arrangements for a first circuit board Gb. The remaining unallocated network connections are bypassed from their network entry points in the board position Gc by a bypass arrangement Gp to the corresponding network exit points in the board position Gc, displaced by the number of allocated network connections, i.e. displaced by one step in this case.

In other words, Gen1 is bypassed to Gex2, Gen2 is bypassed to Gex3, Gen3 is bypassed to Gex4, Gen4 is bypassed to Gex5, Gen5 is bypassed to Gex6, Gen6 is bypassed to Gex7, Gen8 is bypassed to Gex9, Gen9 is bypassed to Gex10, Gen10 is bypassed to Gex11, Gen11 is bypassed to Gex12, Gen12 is bypassed to Gex13 and Gen13 is bypassed to Gex14. In turn, the network exit points Gex8-Gex14 are connected by the backplane-network 550 to the corresponding network entry points Hen8-Hen14 of the subsequent board connector Hc.

The second and third network connections b-c are allocated by the pair of network entry points Hen7, Hen7 and Hen13, Hen14 respectively in the subsequent board position Hc. Hence, the network entry points Hen6, Hen7 and Hen13-Hen14 are used as network connection allocation arrangements for another circuit board Hb. The remaining unallocated network connections are bypassed from their network entry points by a bypass arrangement Hp to the corresponding network exit points in the board position Hc, displaced by the number of allocated network connections, i.e. displaced by two steps in this case.

In other words, Hen1 is bypassed to Hex3, Hen2 is bypassed to Hex4, Hen3 is bypassed to Hex5, Hen4 is bypassed to Hex6, Hen5 is bypassed to Hex7, Hen8 is bypassed to Hex10, Hen9 is bypassed to Hex11, Hen10 is bypassed to Hex12, Hen11 is bypassed to Hex13 and Ben12 is bypassed to Hex14. In turn, the network exit points Hex1-Hex7 are connected by the backplane-network 550 to the corresponding network entry points Gen1-Gen7 of the preceding board connector Gc, whereas the network exit points Hex8-Hex14 are connected to the corresponding network entry points Ien8-Ien14 of the subsequent board connector Ic.

In FIG. 5 there is no board is inserted in the subsequent exemplifying board connector Ic of the backplane 500, or the board inserted in connector Ic requires no network connection. Hence, no network connection is allocated at the board position Ic. The unallocated network connections are all bypassed from the network entry points Ien1-Ien14 by a bypass arrangement Ip to the corresponding network exit points Iex1-Iex14 in the board position Ic. In turn, the network exit points Iex1-Iex7 are connected by the backplane-network 550 to the corresponding network entry points Hen1-Hen7 of the preceding board connector Hc, whereas the network exit points Iex8-Iex14 are connected to the corresponding network entry points Jen8-Jen14 of the subsequent board connector Jc.

The fourth network connection d) is allocated by the pair of network entry points Jen7, Jen14 in the subsequent board position Jc. Hence, the network entry points Jen7, Jen14 are used as network connection allocation arrangements for a third circuit board Jb. The remaining unallocated network connections are bypassed from their network entry points by a bypass arrangement Jp to the corresponding network exit points in the board position Dc, displaced by the number of allocated network connections, i.e. displaced by one step in this case.

In other words, Jen1 is bypassed to Jex2, Jen2 is bypassed to Jex3, Jen3 is bypassed to Jex4, Jen4 is bypassed to Jex5, Jen5 is bypassed to Jex6, Jen6 is bypassed to Jex7, Jen8 is bypassed to Jex9, Jen9 is bypassed to Jex10, Jen10 is bypassed to Jex11, Jen11 is bypassed to Jex12, Jen12 is bypassed to Jex13 and Jen13 is bypassed to Jex14. In turn, the network exit points Jex1-Jex7 are connected by the backplane-network 550 to the corresponding network entry points Ien1-Ien7 of the preceding board connector Ic, whereas the network exit points Jex8-Jex14 are connected to the corresponding network entry points Ken8-Ken14 of the subsequent board connector Kc, i.e. the last board connector in FIG. 5.

The fifth, sixth and seventh network connections e-g are allocated by the pair of network entry points Ken5, Ken6, Ken7 and Ken12, Ken13, Ken14 respectively in the next board position Kc. Hence, the network entry points Ken5-Ken7 and Ken12-Ken14 are used as a network connection allocation arrangement for a fourth circuit board Kb. The remaining unallocated network connections are bypassed from their network entry points by a bypass arrangement Kp to the corresponding network exit points in the board position Kc, displaced by the number of allocated network connections, i.e. displaced by three steps in this case.

In other words, Ken1 is bypassed to Kex4, Ken2 is bypassed to Kex5, Ken3 is bypassed to Kex6, Ken4 is bypassed to Kex7, Ken8 is bypassed to Kex11, Ken9 is bypassed to Kex12, Ken10 is bypassed to Kex13 and Ken11 is bypassed to Kex14. In turn, the network exit points Kex1-Kex7 are connected by the backplane-network 550 to the corresponding network entry points Jen1-Jen7 of the preceding board connector Jc.

The allocation of network connections described above can be summarized in that a first number of the available network connections are allocated at a preceding first board position for a first circuit board—e.g. 0, 1, 2 or 3 connections or even more depending on the bandwidth required by the first board and depending on the number of network connections available in the first board position. The rest of the available connections are fed through to a subsequent second board position. In the second board position a second number of the available network connections (i.e. the unallocated connections fed through from the first board position) is allocated for a second board—0, 1, 2 or 3 connections or even more depending on the bandwidth required by the second board and depending on the number of network connections available in the second board position. The rest of the available connections are fed through to a third board position, wherein a number of network connections needed for a third board are allocated, and so on through all the board connections in the backplane that are to be populated by boards.

The bypass arrangements Gp-Kp mentioned above may e.g. be implemented by means of conducting paths or wires or similar, or switches or switching arrangements or similar as previously discussed with reference to the bypass arrangements Ap-Fp.

The redundant connections that are provided to the board connectors from both sides of the backplane-network 550 as described above can be used to minimize communication loss when a board needs to be replaced. This can e.g. be achieved by means of a redundancy switch 560 being arranged so as to activate the additional network switch arrangement 660′. When a board Gb, Hb, Jb or Kb is removed all the remaining boards will still keep their connections to the neighbours in one direction intact. When a break somewhere between the two sides occurs, the normally broken redundancy switch 560 can be switched on, providing at least a limited communication path between the two sides of the breakpoint. If the bridging of unused network connections on the boards is made passively, this is only expected to occur during board replacement. A simple break detection may be implemented by letting an electrical signal pass in series through all boards, so if any board is not inserted the circuit is no longer closed. The two redundant network switch arrangements 600, 600′ may even be used simultaneously for load sharing during normal operation.

Since networks connections are power consuming and cost money, it is desirable to be able to use them as efficiently as possible. This invention makes it possible to have a general backplane 200, 500 together with a mix of different boards, let them allocate different amounts of network bandwidth and still be able to utilize all available network connections.

The present invention has now been described with reference to exemplifying embodiments. However, the invention is not limited to the embodiments described herein. On the contrary, the full extent of the invention is only determined by the scope of the appended claims.

1. A backplane arrangement comprising a number of board positions each arranged to operatively receive a board, and a backplane-network arrangement arranged to operatively make a plurality of network connections available at a first board position, wherein
a first allocation arrangement is arranged to operatively allocate a set of the available network connections to be used by a board received in the first board position, and
a first bypass arrangement is arranged to operatively bypass a set of the available network connections unallocated at the first board position to a second subsequent board position via the backplane-network arrangement.

2. The backplane arrangement according to claim 1, wherein
said backplane-network arrangement is arranged to operatively make said plurality of network connections available at a second board position, and
a second allocation arrangement is arranged to operatively allocate a redundant set of the network connections unallocated at the first board position to be used by a board received in the second board position.

3. The backplane arrangement according to claim 2, wherein
a second bypass arrangement is arranged to operatively bypass a set of the available network connections unallocated at the second board position to the first board position via the backplane-network arrangement,
a third allocation arrangement is arranged to operatively allocate a redundant set of the network connections unallocated at the second board position to be used by a board received in the first board position.

4. The backplane arrangement according to claim 1, wherein
each bypass arrangement is arranged to bypass the unallocated network connections from network entry points to predetermined network exit points starting and proceeding in a pattern from the same network exit point in each board position.

5. The backplane arrangement according to claim 1, wherein
the first bypass arrangement is arranged to operatively bypass the network connections unallocated at the first board position from network entry points at the first board position to corresponding network exit points at the first board position, displaced by the number of network connections unallocated at the first board position.

6. The backplane arrangement according to claim 2, wherein
the second bypass arrangement is arranged to operatively bypass the network connections unallocated at the second board position from network entry points at the second board position to corresponding network exit points at the second board position, displaced by the number of network connections unallocated at the second position.

7. The backplane arrangement according to claim 1, wherein
at least one of said first or second bypass arrangement is a network switching arrangement that is arranged to operatively in a first switching position bypass the unallocated network connections from network entry points at said board position to corresponding network exit points at said board position, displaced by the number of network connections unallocated at said board position, and in a second switching position bypass the unallocated network connections from network entry points at said board position to corresponding network exit points at said board position without any displacement.

8. The backplane arrangement according to claim 1, wherein
at least one of said first or second bypass arrangement is a network switching arrangement that is arranged to operatively bypass the unallocated network connections from their network entry points respectively at said board position to any network exit point at said board position, so as to provide a point-to-point connection between each of said network entry points and a network exit point.

9. The backplane arrangement according to claim 1, wherein
at least one of said bypass arrangements is a part of the board inserted at the board position in question.

10. A board magazine comprising a backplane arrangement according to claim 1.

11. A method for distributing network connections in a backplane arrangement comprising a number of board positions each arranged to operatively receive a board, and a backplane-network arrangement arranged to operatively make a plurality of network connections available at a first board position, comprising the steps of:
at a first allocation arrangement, allocating a set of the available network connections to be used by a board received in the first board position, and
at a first bypass arrangement, bypassing a set of the available network connections unallocated at the first board position to a second subsequent board position via the backplane-network arrangement.

12. The method according to claim 11, comprising the steps of:
by said backplane-network arrangement, making said plurality of network connections available at a second board position, and
at a second allocation arrangement, allocating a redundant set of the network connections unallocated at the first board position to be used by a board received in the second board position.

13. The method according to claim 12, comprising the steps of:
at a second bypass arrangement, bypassing a set of the available network connections unallocated at the second board position to the first board position via the backplane-network arrangement,
at a third allocation arrangement, allocating a redundant set of the network connections unallocated at the second board position to be used by a board received in the first board position.

14. The method according to claim 1, comprising the steps of:
at each bypass arrangement, bypassing the unallocated network connections from network entry points to predetermined network exit points starting and proceeding in a pattern from the same network exit point in each board position.

15. The method according to claim 1, comprising the steps of:
at the first bypass arrangement, bypassing the network connections unallocated at the first board position from network entry points at the first board position to corresponding network exit points at the first board position, displaced by the number of network connections unallocated at the first board position.

16. The method according to claim 12, comprising the steps of:
at the second bypass arrangement, bypassing the network connections unallocated at the second board position from network entry points at the second board position to corresponding network exit points at the second board position, displaced by the number of network connections unallocated at the second position.

17. The method according to claim 11, comprising the steps of:
in at least one of said first or second bypass arrangement being a network switching arrangement, bypassing in a first switching position the unallocated network connections from network entry points at said board position to corresponding network exit points at said board position, displaced by the number of network connections unallocated at said board position, and in a second switching position bypassing the unallocated network connections from network entry points at said board position to corresponding network exit points at said board position without any displacement.

18. The method according to claim 11, comprising the steps of:
in at least one of said first or second bypass arrangement being a network switching arrangement, bypassing the unallocated network connections from their network entry points respectively at said board position to any network exit point at said board position, so as to provide a point-to-point connection between each of said network entry points and a network exit point.
